(19) United States
(12) Patent Application Publication
(10) Pub. No.: US 2026/0326345 A1
(43) Pub. Date: Oct. 22, 2026

(54) MOLD CHANGEOVER TABLE FOR PRODUCING A CORRUGATED TUBE

(71) Applicant: Cooper-Standard Automotive Inc., Northville, MI (US)

(72) Inventor: Jesse Richard Whipkey, Oscoda, MI (US)

(73) Assignee: Cooper-Standard Automotive Inc., Northville, MI (US)

(21) Appl. No.: 19/186,577

(22) Filed: Apr. 22, 2025

(51) Int. Cl. B29C 33/30; B29C 48/00; B29C 48/13

(52) U.S. Cl. CPC B29C 33/30; B29C 48/0019; B29C 48/13

(57) ABSTRACT

Disclosed herein is a table for supporting a plurality of molds for forming a plastic tubing. The table has a deck mounted on the table having a mold insertion track running along the deck. A pusher is slidably mounted in the insertion track. The insertion track is dimensioned to accommodate a plurality of molds in abutting relationship to form a continuous cavity within the plurality of molds to form the plastic tubing having a desired geometry.

### FIELD

The field is related to a process and apparatus for loading molds into a corrugator of an extrusion system for forming tubular products, and more particularly, a table for holding a set of replacement molds to be driven into a corrugator replacing existing molds to form a tubular product for conveying fluids in a vehicle cooling system, for example.

### BACKGROUND

A corrugator is a machine used in the processing of plastics to form tubular products such as hoses, pipes, and tubes. The corrugator supports a plurality of molds each of which represents a negative mold of an external geometry of the tubular product. External geometries can include smooth surfaces, undulating surfaces, textured surfaces, for example. Molds may come in pairs for ease of disassembly. A length of tube may be made from a train of mold pairs. By selecting and positioning the molds in a sequence, a desired geometry of the tubular product can be achieved. Pairs of molds can be separated after molding a segment of tube and replaced as a pair at the end of the train to mold a continuous length of tube that is longer than the length of the mold train. With the aid of a corrugator of this type, a continuous tubular product can be made and then cut to length for sale and use. The corrugator works in conjunction with an extruder to place the plurality of molds in communication with a flow of molten polymeric material from the extruder to form a tubular product of a desired geometry.

One limitation to forming tubular products in this fashion is the downtime of the corrugator and extruder during a mold changeover. During a mold changeover, the corrugator and extruder are deactivated while a first plurality of molds are removed from the corrugator, a second plurality of molds are placed in a desired sequence, and the second plurality of molds is inserted into the corrugator. It is desirable to dispense with a lengthy changeover period by enhancing the speed of the process with a mobile changeover table described herein.

### SUMMARY

The disclosure relates to a table for supporting a plurality of molds for forming a plastic tubing. The table has a deck mounted on the table which includes a mold insertion track running along the deck. A mobile support member may be attached to the table to allow for movement of the table. A pusher is slidably mounted in the insertion track. The insertion track is dimensioned to accommodate a plurality of molds in abutting relationship to form a continuous cavity within the plurality of molds to form the plastic tubing having a desired geometry.

The disclosure also relates to a method for changing over a first plurality of molds in a corrugator including: (1) providing a table having a deck mounted thereon, the deck having a mold insertion track running along the deck, a mobile support member may be attached to the table to allow for movement of the table; (2) positioning a second plurality of molds in the mold insertion track in abutting relationship; (3) optionally moving the table into engagement with the corrugator; and, (4) moving the second plurality of molds along the deck into engagement with the first plurality of molds to replace the first plurality of molds in the corrugator.

The disclosure also relates to a method for making a tubing including: (1) providing a table having a deck mounted thereon, the deck having a mold insertion track running along the deck, a mobile support member may be attached to the table to allow for movement of the table; (2) positioning a plurality of molds in the mold insertion track in abutting relationship to form a continuous cavity within the plurality of molds to form the plastic tubing having a desired geometry; (3) optionally moving the table into engagement with the corrugator; and, (4) delivering fluid plastic under pressure into the continuous cavity to form the tubing.

### BRIEF DESCRIPTION OF THE DRAWINGS

FIG. 1 is a perspective side view of a mobile table for supporting a plurality of molds.

FIG. 2 is a perspective side view of a deck to show a lateral edge of the deck.

FIG. 3 is a perspective side view of the deck.

FIG. 4 is a top plan view of a corrugator.

FIG. 5 is a top plan view of an alternative embodiment of a deck of a mobile table supporting a plurality of molds.

FIG. 6 is a top plan view of an alternative embodiment of deck of a mobile table supporting a plurality of molds.

FIG. 7 is a schematic view of a block for forming a mold for corrugated tubular products.

FIG. 8 is a schematic view of a block for forming a mold for smooth-walled tubular products.

FIG. 9 is a schematic view of a mold for forming tubular products.

FIG. 10 is a side view of a tubular product having a desired geometry.

FIG. 11 is a schematic bottom view of a deck of a mobile table and a corrugator showing features to ensure proper alignment.

While the following is described in conjunction with specific embodiments, it will be understood that this description is intended to illustrate and not limit the scope of the preceding description and the appended claims.

### DETAILED DESCRIPTION

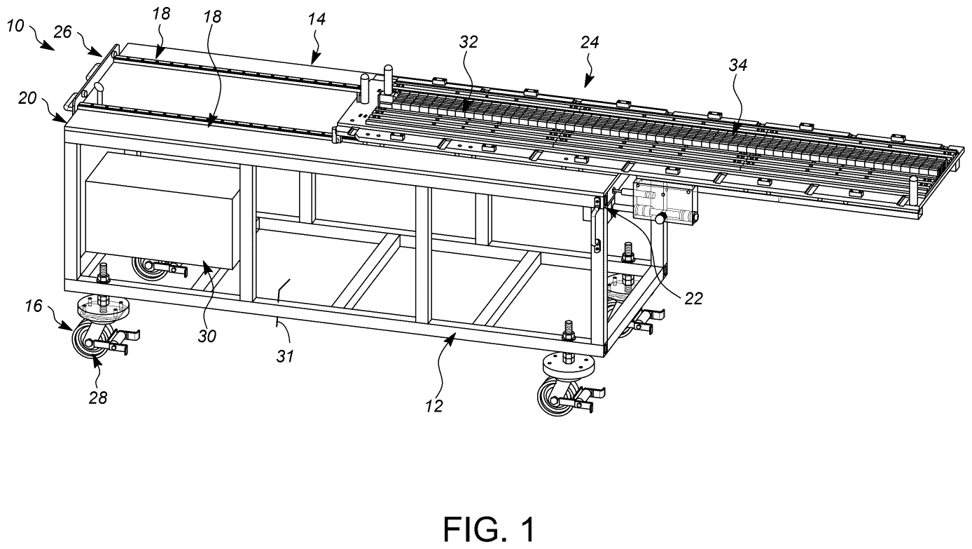

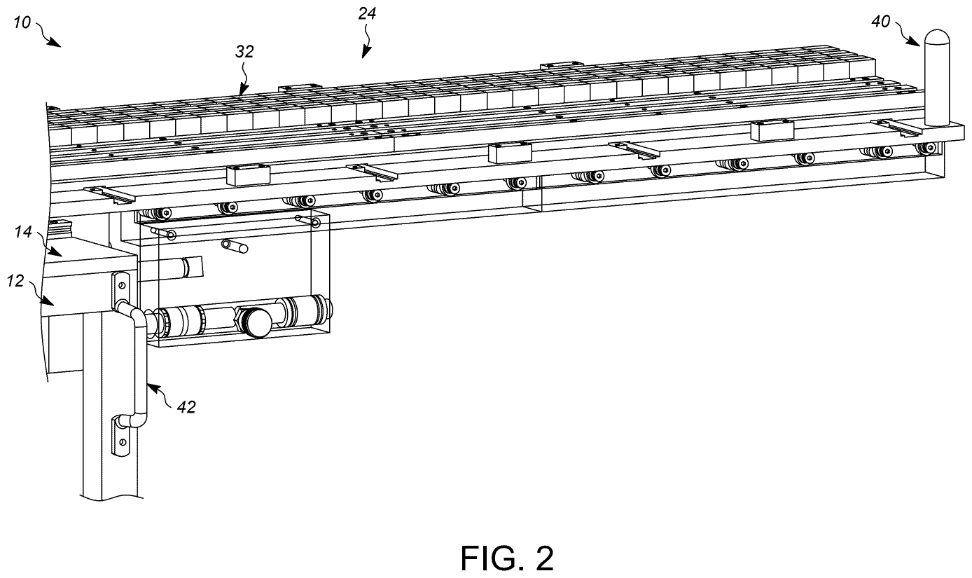

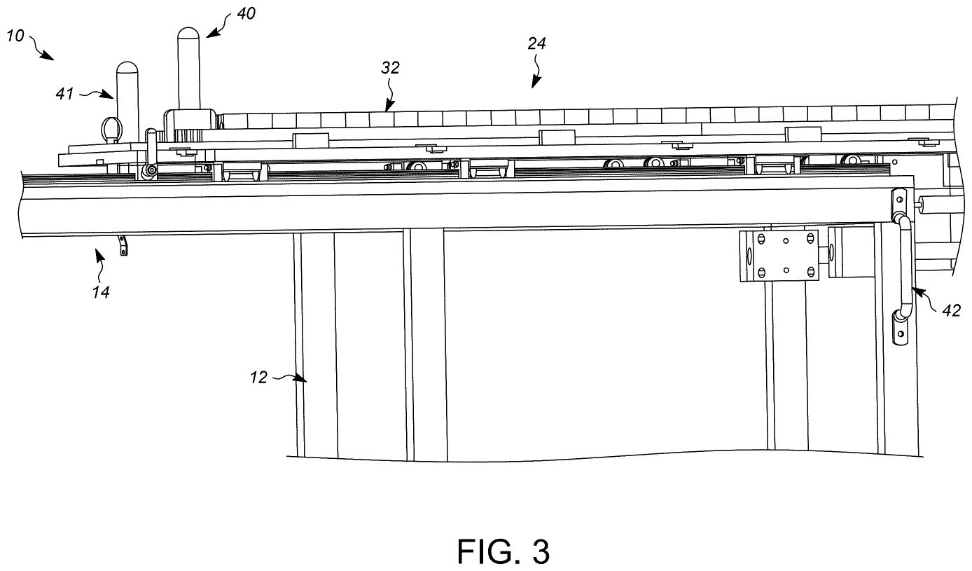

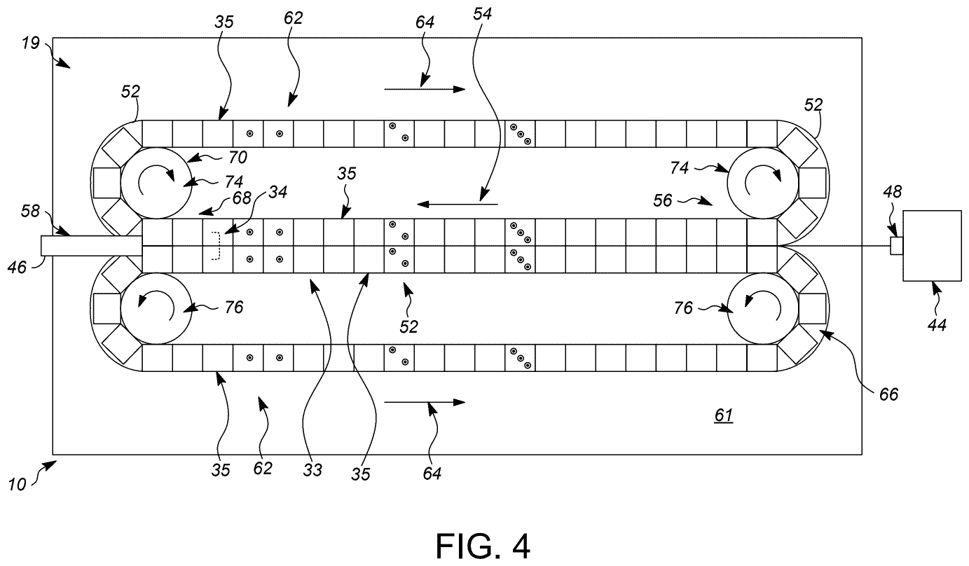

FIG. 1 shows a changeover table 10 having a frame 12 supporting a tabletop 14, and a support unit 16 attached to the frame 12. In an embodiment the support unit 16 is mobile. The tabletop 14 has a pair of tracks 18 extending along a portion of the tabletop 14, and more preferably from a first end 20 to a second end 22. A deck 24 is mounted in the tracks 18 for sliding reciprocating translational movement there along from a stowed condition (FIG. 3) to a deployed condition as shown in FIGS. 1-2. In the deployed condition, the deck 24 can be positioned on top of a corrugator 19 (FIG. 4) to transfer a plurality of molds 34 from the deck to the corrugator for molding a tube. Preferably, the deck 24 can also be slid laterally on the tabletop 14 in a direction transverse to the pair of tracks 18 to facilitate alignment of the deck 24 with a corrugator 19 (FIG. 4) as will be described in greater detail below. An end stop formed by an upstanding wall 26 is positioned at the first end 20 prevents the deck 24 from sliding off the first end 20.

The frame 12, as shown, is fabricated from square metal tubing material but could be fabricated with other materials. The support unit 16 may have a set of casters 28 mounted to the frame 12. The support unit 16 could also include wheels, sliders, or other suitable ground engaging mechanisms to provide mobility. An optional counterweight 30 is shown on the frame 12 to prevent the table 10 from tipping over, especially when the deck 24 is in the deployed condition. A ground engaging pin 31 is mounted on the frame and is moveable from a stowed condition to a deployed condition. When in the stowed condition the pin 31 does not contact the ground and when in a deployed condition, the pin engages the ground to resist the table from moving.

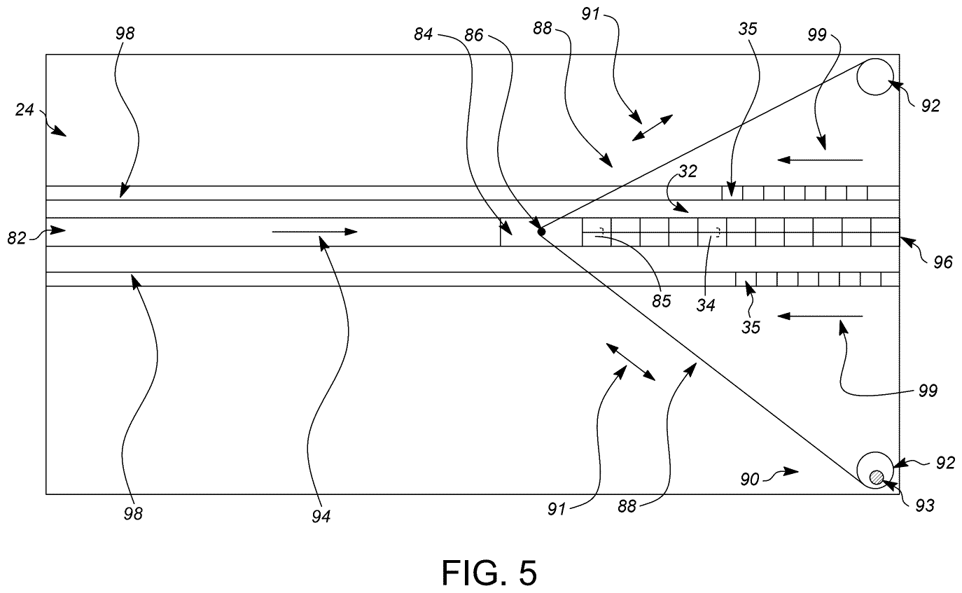

A first plurality of molds 32 is mounted to a top side of the deck 24 in abutting relationship (FIG. 5) and a second plurality of molds 33 is on a platform 61 of the corrugator 19 (FIG. 4).

Each mold 34 is made from a pair of blocks 35 as shown in FIG. 9. Each mold 34 includes two rectangular blocks 35 that each include a half bore extending longitudinally that is smooth or includes ridges. The smooth molds 34 are for forming smooth-walled tubing. As shown in FIG. 4, molds 34 containing no pips are for forming corrugated walls. Molds 34 with one pip may be smooth. Molds 34 with two pips are for forming irregular-shaped tubing, and those molds 34 with three pips are for forming textured surfaces. A given length of tubular product may have any combination of these molds 34. The number of each type of the molds 34 and their sequential placement is determined to form the desired geometry of the molded tubing.

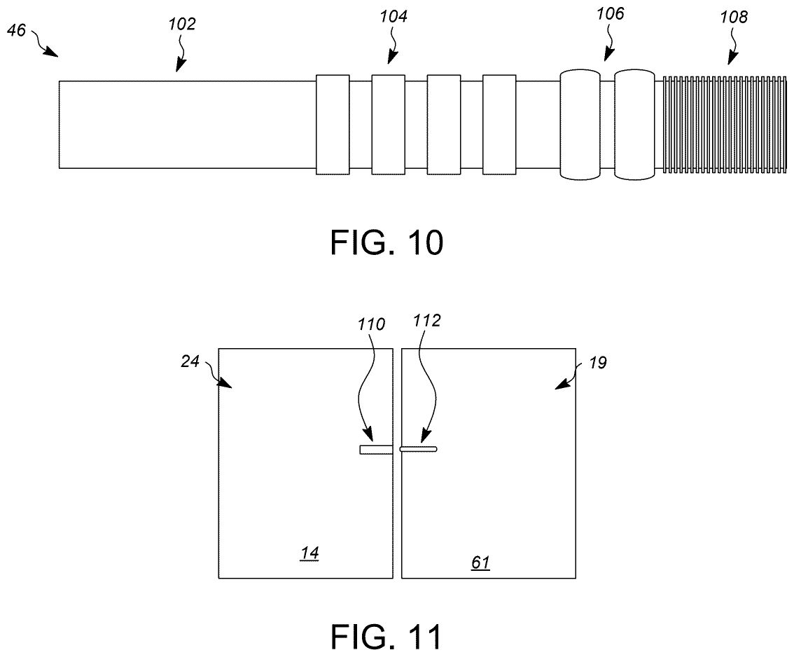

FIG. 10 shows a tubular product 46 having a smooth outer surface 102, a corrugated outer surface 104, an irregular surface 106, and a textured surface 108.

As shown in FIG. 5, a human or other operator selects the required molds 34 from a source of molds and places them in the proper sequence on the top side of the deck 24 to form the first plurality of molds 32. As shown in FIG. 4, after extruding a desired length of tubing having a first desired geometry, the second plurality of molds 33 on the platform 61 of the corrugator 19 must be changed out with the first plurality of molds 32 on the deck 24 of the changeover table 10 to make a tubular product of a second desired geometry different from the first geometry. Conventionally, during the mold changeover, the corrugator 19 and an extruder 44 would be idle. The changeover table 10 facilitates rapid replacement of the second plurality of molds 33 with the first plurality of molds 32 so that the down time of the corrugator 19 and the extruder 44 is minimized.

FIG. 2 shows a side view of the deck 24 in the deployed position. FIG. 3 shows the entire deck 24 that both lateral sides of the deck 24 are symmetrically configured similarly. The deck 24 has an upstanding handle 40 for moving the deck 24 along the tabletop 14. Optionally, the deck can have a second handle 41 (FIG. 3). Likewise, the frame 12 has an optional handle 42 for moving the table 10 if mobile from location to location. As shown in FIG. 11, an alignment groove 110 on a bottom of the deck 24 of the changeover table 10 may engage with a ridge 112 on a bottom of the platform 61 of the corrugator 19 to ensure correct alignment between the deck 24 and the corrugator 19.

FIG. 4 shows a corrugator 19 and an extruder 44 for forming tubing 46 of a desired geometry as a continuous product that is cut to length in a downstream cutting station (not shown). The extruder 44 can be single-screw extruder or a twin-screw extruder. Preferably, the extruder 44 is capable of extrusion and coextrusion. The extruder 44 has an injection head 48 for delivering fluid, uncured plastic material to the corrugator 19.

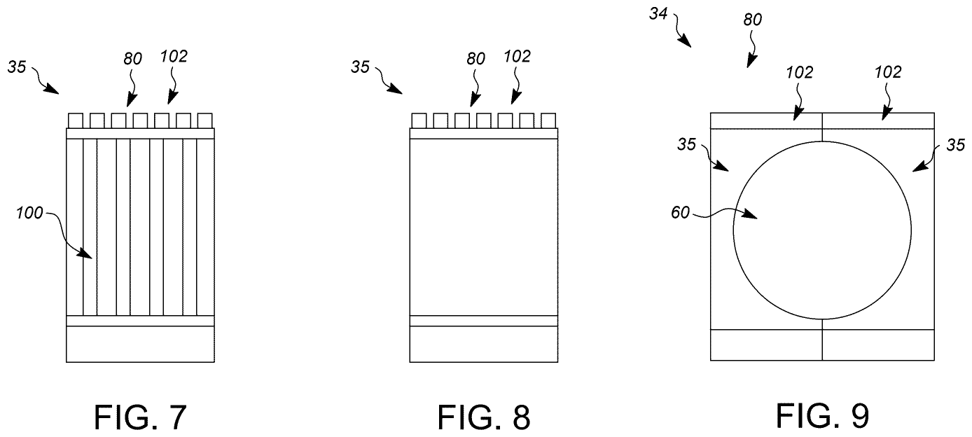

The corrugator 19 has a guide track 52 in the platform 61. The molds 34 move in a first direction 54 from a starting location 56 toward an outlet location 58. A pair of blocks 35 are brought together in an insertion station 66 at the starting location 56 to form a mold 34 with an inner cavity 60 (FIG. 9). The molds 34 are separated in a separation station 68 into two individual blocks 35 at the outlet location 58 and directed in individual return tracks 62 in a second direction 64 opposite from the first direction 54 toward the starting location 56 where the cycle will start over. Each insertion station 66 and separation station 68 have a pair of wheels 70 mounted for rotational motion about an axle. Each pair of wheels 70 has a first wheel 74 and a second wheel 76 that rotate in opposite angular directions and are spaced from one another. The wheels 70 have a groove in a peripheral surface dimensioned to receive blocks 35 and to carry the blocks 35 through 180° to reverse the direction the blocks 35 have been traveling and to change the flow of blocks 35 from the guide track 52 to the return tracks 62. A drive installation (not shown) can be provided for transporting the molds 34 and the blocks 35 along the guide track 52 and return tracks 62. The drive installation can be a pinion which engages in a form-fitting manner in a toothing 80 provided on the blocks as shown in FIGS. 7-9. A control unit (not shown) connected to the drive installation can control the movement of the blocks 35 in the extrusion process. Uncured plastic from the extruder injection head 48 is metered through the molds 34 to form the desired tubing geometry in a continuous tube.

FIG. 5 shows an example first embodiment of the deck 24 with the first plurality of molds 32 mounted in a mold insertion track 82 for reciprocal sliding engagement there along. The number of insertion tracks 82 can be from 1 to 5, more preferably 1 to 4, and most preferably 1 to 3. A pusher 84 is positioned in the mold insertion track 82 and abuts a terminal mold 85. The pusher 84 has a protuberance 86 extending from a surface and connected by a web of material 88 to a drive unit 90 which moves the web of material back and forth in the direction of arrow 91. The web of material 88 can be, for example, string, thread, wire, cable, rope, chain, or other type of material. The drive unit 90 shown has a pair of wheels 92 that control the length of the web of material 88. One wheel 92 has a handle 93 that when rotated counterclockwise shortens the web of material 88 and forces the first plurality of blocks 32 in the direction 94 toward an exit end 96 of the deck 24. In a mold changeover procedure, the first plurality of molds 32 will replace the second plurality of molds 33 in the corrugator 19. A pair of return tracks 98 flank the mold insertion track 82 and receive the second plurality of blocks 35 from the corrugator during a changeover procedure in a direction 99. Preferably, there will be two return tracks 98 with each insertion track 82.

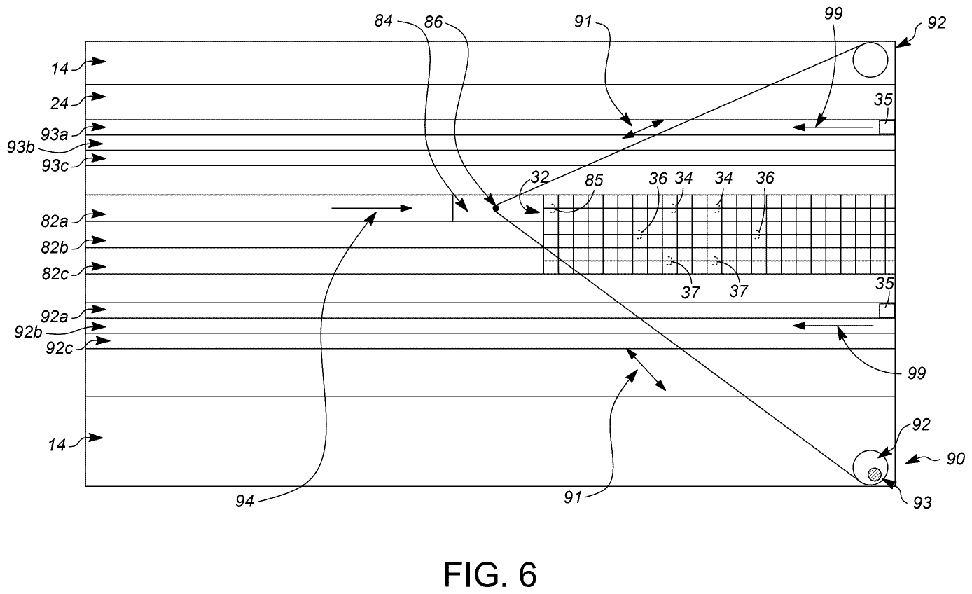

FIG. 6 shows a second embodiment of the deck 24 that differs from the second embodiment by having three mold insertion tracks 82a, 82b, 82c each flanked on both sides by three return tracks 92a, 92b, 92c on the right of the mold insertion tracks and 93a, 93b, 93c on the left of the insertion track for a total of six return tracks. In a mold changeover procedure, the first plurality of molds 32 in the first insertion track 82a can be inserted and pushed into the guide track 52 of the corrugator 19 from the deck 24. At the same time two blocks 35 for each mold are pushed onto the deck 19, one of each block, in the right return track 92a and the left return track 93a. The process can be repeated for the plurality of molds 32 assembled in the insertion tracks 82b and 82c.

For example, the first plurality of molds 32 in track 82a can be pushed onto the corrugator platform 61 and receive separated blocks 35 into return tracks 92a and 93a. Track 82a and return tracks 92a and 93a are the tracks closest to the top left side of the deck 24. When it is time to load a third plurality of molds 36 in track 82b onto the corrugator platform 61, the table 10 is shifted to the right to align the middle track 82b with the guide track 52 of the corrugator and the second plurality of molds 33 are returned into the middle return tracks 92b and 93b. When it is time to load a fourth plurality of molds 37 in track 82c onto the corrugator platform 61, the table 10 is shifted to the right to align the right track 82c with the guide track 52 of the corrugator 19 and the third plurality of molds 36 are returned into the right return tracks 92c and 93c.

FIG. 7 shows a block 35 for forming corrugated tubing, and FIG. 8 shows a block 35 for forming a smooth wall tubing. FIG. 9 shows the mold 34 formed by a pair of blocks 35 brought together in cooperative engagement and aligned vertically. The inner cavity 60 of the corrugated block 35 has channels 100 that are filled with molten plastic material to form a corrugated outer surface of the tubular product. Molten plastic is delivered to the molds 34 under pressure to inner cavities 60 under vacuum, so the plastic molds to an inner wall of the cavity to take the desired tubing shape. Each block has a plurality of teeth 102 that define the toothing 80 mentioned above.

FIG. 11 shows a bottom view of the deck 24 and the corrugator 19 platform 61 with alignment features to ensure proper alignment of the two. An alignment groove 110 is positioned on the bottom of the deck and a raised ridge 112 is positioned on the bottom of the corrugator 19. The ridge 112 fits within the groove 110 when the deck 24 and the corrugator 19 are properly aligned. An additional transition piece may be used to further ensure proper alignment.

Now to describe a method for using the table 10 in a mold changeover procedure. The first step provides a table 10 having a deck 24 having a mold insertion track 82 running along the deck, the table optionally having a mobile support member 16 to allow for movement of the table. The second step requires positioning a first plurality of molds 32 in pairs into the mold insertion track 82 in abutting relationship in a desired sequence to form a tubular product with a desired geometry. The third step requires optionally moving the table 10 and necessarily the first plurality of molds 32 into engagement with the corrugator 19 having a guide track 52 containing the second plurality of molds 33 and optionally a pair of return tracks 62 containing a second plurality of blocks 35. The third step may optionally include engaging a groove on the table 10 with a ridge on the corrugator or vice-versa to facilitate alignment. The fourth step requires moving the first plurality of molds 32 along the deck 24 to replace the second plurality of molds 33 in the corrugator 19. Preferably, the first plurality of molds 32 are moved from the deck 24 into the guide track 52 of the corrugator 19. This step may involve moving the first plurality of molds 32 into engagement with the second plurality of molds 33. The fifth step requires optionally directing the second plurality of molds 33 from the corrugator to a return track 98 on the deck 24. The fifth step optionally includes separating the second plurality of molds 33 into trains of blocks 35 in the return tracks 62 on the corrugator platform 61 and moving them onto return tracks 98 on the table 10. The sixth step requires optionally moving the mobile table 10 away from the corrugator 19.

The changeover table 10 can be operated using scheduling software to reduce the downtime of the equipment and the amount of scrap material produced. The changeover table 10 can be used to produce part numbers of tubular products of differing lengths. When the length of a tubular product is not evenly divisible by the length of tubing produced by each block 34, scrap material is produced. For example, if each block produces a 37 mm length of tubular product, a first part of 380 mm length requires 11 molds. This produces a part 407 mm in length leaving a 27 mm length of scrap material per part produced. To reduce this scrap, second part can be generated simultaneously with the first part and utilize all or part of the excess material in the second part. Thus, the changeover table can be operated to continuously produce the first part and then the second part and continue this cycle until the desired length of product is produced. A sorting table (not shown) positioned adjacent to the cutter can sort the two parts into separate bins. This process also reduces the changeover table 10 downtime as the table does not have to be changed over from making the first part to the second part.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

1. A table for supporting a plurality of molds for forming a plastic tubing, the table comprising:
a deck mounted on the table having a mold insertion track running along the deck;
a pusher slidably mounted in the mold insertion track; and
wherein the mold insertion track is dimensioned to accommodate a plurality of molds in abutting relationship to form a continuous cavity within the plurality of molds to form the plastic tubing having a desired geometry.

2. The table of claim 1 wherein each of the molds comprises two blocks.

3. The table of claim 1 wherein the deck is mounted for reciprocating translational movement on the table.

4. The table of claim 1 further comprising a pair of block return tracks flanking the mold insertion track.

5. The table of claim 1 further comprising a driver mounted on the table.

6. The table of claim 5 wherein the pusher moves the plurality of molds along the insertion track in response to activation of the driver.

7. The table of claim 6 wherein the driver is a handwheel connected to the pusher with a web of material.

8. The table of claim 6 wherein the pusher has a protuberance connected to the web of material.

9. The table of claim 8 wherein the protuberance extends from an upper surface of the pusher.

10. The table of claim 1 further comprising a mobile support unit connected to the table including wheels, casters or gliders.

11. The table of claim 1 further comprising a second insertion track flanked by a second pair of block return tracks.

12. A method for changing over molds in a corrugator comprising:
providing a table having a deck, the deck having a mold insertion track running along the deck;
positioning a first plurality of molds in the mold insertion track in abutting relationship; and
optionally moving the table into engagement with the corrugator having a guide track containing a second plurality of molds and a pair of return tracks.

13. The method of claim 12 further comprising a pair of block return tracks flanking the mold insertion track optionally containing a third plurality of blocks.

14. The method of claim 13 further comprising moving the first plurality of molds along the deck into engagement with the second plurality of molds to replace the second plurality of molds in the corrugator.

15. The method of claim 14 further comprising moving the first plurality of molds into the guide track.

16. The method of claim 15 further comprising optionally directing the second plurality of molds from the corrugator to a return track on the deck.

17. The method of claim 16 further comprising separating the second plurality of molds into trains of blocks in return tracks on the corrugator and moving them onto the pair of return tracks on the table.

18. A method for making a tubing comprising:
providing a table having a deck mounted thereon, the deck having a mold insertion track running along the deck;
positioning a plurality of molds in the mold insertion track in abutting relationship to form a continuous cavity within the plurality of molds to form the plastic tubing having a desired geometry;
moving the table into engagement with a corrugator and moving the plurality of molds onto the corrugator and
delivering fluid uncured plastic material under pressure into the continuous cavity to form the tubing.

19. The method of claim 18 wherein each mold is formed by two blocks and further comprising a pair of block return tracks flanking the insertion track each optionally containing a plurality of blocks.

20. The method of claim 18 further comprising providing a pusher to move the plurality of molds along the deck into the corrugator.
